(19) United States
(12) Patent Application Publication
(10) Pub. No.: US 2022/0224176 A1
(43) Pub. Date: Jul. 14, 2022

(54) PERMANENT MAGNET ASSISTED SYNCHRONOUS RELUCTANCE MACHINE

(71) Applicants: Lakshmi IYER, Troy, MI (US); Gerd SCHLAGER, Sankt Valentin (AT); MAGNA INTERNATIONAL INC., Aurora (CA)

(72) Inventors: Lakshmi Varaha IYER, Troy, MI (US); Gerd SCHLAGER, Sankt Valentin (AT)

(21) Appl. No.: 17/440,959

(22) PCT Filed: Mar. 20, 2020
(86) PCT No.: PCT/US2020/023769

§ 371 Date: Sep. 20, 2021

Related U.S. Application Data
(60) Provisional application No. 62/821,272, filed on Mar. 20, 2019.

(51) Int. Cl. H02K 1/276; H02K 1/02; H02K 1/16; H02K 21/14

(52) U.S. Cl. CPC H02K 1/2766; H02K 21/14; H02K 1/16; H02K 1/02

(57) ABSTRACT

A permanent magnet assisted synchronous reluctance machine includes a stator that includes a plurality of electrical conductors radially disposed on the stator. The permanent magnet assisted synchronous reluctance machine also includes a rotor that includes a body having an outer diameter corresponding to an inner diameter of the stator and a plurality of recesses disposed on a surface of the rotor. The permanent magnet assisted synchronous reluctance machine also includes at least one ferrite magnet disposed in a corresponding recess of the rotor.

### CROSS-REFERENCE TO RELATED APPLICATIONS

This PCT International Patent Application claims the benefit of and priority to U.S. Provisional Patent Application Ser. No. 62/821,272, filed Mar. 20, 2019, titled “Permanent Magnet Assisted Synchronous Reluctance Machine,” the entire disclosure of which is hereby incorporated by reference.

### TECHNICAL FIELD

The present disclosure relates generally to permanent magnet synchronous machines.

### BACKGROUND

Permanent magnet synchronous machines, such as electric motors or generators, commonly include a stationary part called a stator. Energy flows through the stator to or from a rotating component, such as a rotor that rotates. Stators commonly include one or more multiphase electrical conductors comprising a core wound in conductive wire. The rotating component typically includes one or more permanent magnets radially disposed on the rotor. The permanent magnets, such as neodymium (NdFeB) permanent magnets or other suitable magnets, typically include high dysprosium content, which may be relatively expensive. An electrical current is applied or induced in the electrical conductors to generate a magnetic field that transfers energy to or from the rotating component, which may cause the rotating component to rotate.

Typically, at a steady state, a rotation of a shaft of a permanent magnet synchronous machine is synchronized with a frequency of the electrical current applied or induced in the electrical conductors of the stator. A rotation period of the rotor is typically equal to an integral number of power cycles associated with the electrical current. Such machines typically yield desirable characteristics in operation. However, manufacturing costs of permanent magnet synchronous machines comprising NdFeB permanent magnets and/or magnets with high dysprosium content may be relatively high.

### SUMMARY

This disclosure relates generally to permanent magnet synchronous machines.

An aspect of the disclosed embodiments includes a permanent magnet assisted synchronous reluctance machine that includes a stator that includes a plurality of electrical conductors radially disposed on the stator and a rotor that includes a body having an outer diameter corresponding to an inner diameter of the stator and a plurality of recesses disposed on a surface of the rotor. The permanent magnet assisted synchronous reluctance machine also includes at least one ferrite magnet disposed in a corresponding recess of the plurality of recesses.

Another aspect of the disclosed embodiments includes an electric machine. The electric machine includes a stator that includes a plurality of electrical conductors radially disposed on the stator. The electric machine also includes a rotor that includes a body having an outer diameter corresponding to an inner diameter of the stator and a plurality of recesses disposed on a surface of the rotor. The electric machine also includes at least one magnet disposed in a corresponding recess of the plurality of recesses and an air gap disposed proximate the at least one magnet, wherein the rotor is configured to cause magnetic flux generated by the at least one magnet to be directed toward the air gap.

Another aspect of the disclosed embodiments includes a permanent magnet assisted synchronous reluctance machine that includes a stator that includes a plurality of electrical conductors radially disposed on the stator and a rotor that includes a body having an outer diameter corresponding to an inner diameter of the stator and at least a first recess and a second recess disposed on a surface of the rotor. The permanent magnet assisted synchronous reluctance machine also includes an iron bridge disposed between the first recess and the second recess, a first magnet disposed in one of the first recess and the second recess, and a second magnet disposed in the other of the first recess and the second recess. The permanent magnet assisted synchronous reluctance machine also includes a first air gap disposed proximate the first recess and a second air gap disposed proximate the second recess, wherein rotation of the rotor causes magnetic flux generated by the first magnet and the second magnet to be directed toward the first air gap and the second air gap.

Another aspect of the disclosed embodiments includes a permanent magnet assisted synchronous reluctance machine that includes a combination of ferrite magnets and NdFeB magnets disposed in recesses of a rotor to achieve a high torque density and constant power region at low cost.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates partial top view of a permanent magnet assisted synchronous reluctance machine according to the principles of the present disclosure.

FIG. 1B generally illustrates partial top view of an alternative permanent magnet assisted synchronous reluctance machine according to the principles of the present disclosure.

FIG. 1C generally illustrates partial top view of an alternative permanent magnet assisted synchronous reluctance machine according to the principles of the present disclosure.

FIG. 1D generally illustrates partial top view of an alternative permanent magnet assisted synchronous reluctance machine according to the principles of the present disclosure.

FIG. 1E generally illustrates partial top view of an alternative permanent magnet assisted synchronous reluctance machine according to the principles of the present disclosure.

FIG. 1E generally illustrates partial top view of an alternative permanent magnet assisted synchronous reluctance machine according to the principles of the present disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, typical permanent magnet synchronous machines comprising neodymium (NdFeB) permanent magnets and/or magnets with high dysprosium content may be relatively expensive to manufacture. Synchronous reluctance machines may provide an alternative to permanent magnet synchronous machines. As the name suggests, such machines are designed to produce a high reluctance torque component. Synchronous reluctance machines include electric motors or generators that include non-permanent magnetic poles on a ferromagnetic rotor. Typically, the rotor of synchronous reluctance machines does not include any windings and torque of the synchronous reluctance machine is generated through magnetic reluctance. However, such synchronous reluctance machines typically do not yield desirable operating efficiency characteristics, output power characteristic, and/or power density characteristics in operation. Accordingly, permanent magnet synchronous machines, such as the permanent magnet assisted synchronous reluctance machines described herein, that achieve similar output characteristics, as typical permanent magnet synchronous machines, at a lower manufacturing cost, and overcome the undesirable characteristics of synchronous reluctance machines, may be desirable.

According to some embodiments, the permanent magnet assisted synchronous reluctance machines described herein are configured to lower manufacturing costs of typical permanent magnet machines that comprise NdFeB magnets and/or magnet with high dysprosium content. In some embodiments, the permanent magnet assisted synchronous reluctance machines described herein are configured to improve operational efficiency, improve constant output power characteristics, improve power density characteristics, improve other suitable characteristics, or a combination thereof compared to typical synchronous reluctance machine that do not include magnets in a corresponding rotor.

In some embodiments, the permanent magnet assisted synchronous reluctance machines described herein include at least one ferrite component. In some embodiments, the ferrite component may include a ferrite magnet. Ferrite magnets may cost significantly less than typical NdFeB magnets (e.g., such as 90% less).

In some embodiments, the permanent magnet assisted synchronous reluctance machines described herein include at least some ferrite magnets and at least some NdFeB magnets, as a mixture of two magnet types. In some embodiments, the permanent magnet assisted synchronous reluctance machines described herein include a rotor configured to generate high torque density and to operate at a relatively high efficiency. For example, the permanent magnet assisted synchronous reluctance machines described herein include may include at least one ferrite magnet, as described. The at least one ferrite magnet may have operating characteristics, such as a relatively low remnant flux density compared to typical NdFeB magnets operating at the similar temperatures, which may cause the rotor to generate high torque density and operate at a relatively high efficiency, as desired.

In some embodiments, the permanent magnet assisted synchronous reluctance machines described herein include a rotor configured to be relatively highly salient, such that the rotor may include a relatively high component of reluctance torque. Additionally, or alternatively, the permanent magnet assisted synchronous reluctance machines described herein include a rotor configured to generate a magnet torque component when the permanent magnet assisted synchronous reluctance machines include at least one ferrite magnet and/or a combination of at least one ferrite magnet and at least one NdFeB magnet. It is also found that the magnets in the rotor boost torque production in the constant power region. Moreover, a mix of these magnet types can boost torque production at reduced overall cost of magnets used.

In some embodiments, the permanent magnet assisted synchronous reluctance machines described herein include a rotor configured to accommodate mechanical forces acting at high speed and torque conditions when the permanent magnet assisted synchronous reluctance machines are in operation. In some embodiments, the permanent magnet assisted synchronous reluctance machines described herein include a rotor comprising a combination of features and characteristics of any of the rotors described herein. For example, the permanent magnet assisted synchronous reluctance machines described herein include a rotor comprising recesses disposed on a surface of the rotor. The recesses are configured to retain a corresponding magnet.

In some embodiments, one or more of the recesses of the rotor are empty (e.g., do not include a magnet). In some embodiments, the some recesses are empty and some recesses include magnets. The magnets included in some of the recesses may include ferrite magnets, NdFeB magnets, or a combination thereof. In some embodiments, the recesses may comprises similar dimensions. In some embodiments, some recesses may include a first set of dimensions (e.g., a width and/or a length) and some recesses include a second set of dimensions, different from the first set of dimensions. In some embodiments, the various sets of dimensions correspond to respective recesses (e.g., the recesses may be of various sizes).

In some embodiments, the permanent magnet assisted synchronous reluctance machines described herein include a rotor having one or more bridges disposed between the corresponding recesses having similar or dissimilar sets of dimensions. The bridges may comprise iron or other suitable material. In some embodiments, a number of layers of recesses of the rotor and a number of bridges may be equal and may comprise than two layers of recesses and two bridges.

In some embodiments, the permanent magnet assisted synchronous reluctance machines described herein include a stator that may be wound for multi-phases in a distributed winding or concentrated winding fashion. In some embodiments, he permanent magnet assisted synchronous reluctance machines described herein include a stator that may be wound for three-phases or more than three-phases in a distributed winding or concentrated winding fashion. Moreover, the rotor could have copper coils wound around the slots instead of magnets placed inside the slots to produce rotor flux. These coils could be excited from an external supply to the rotor or could be supplied by the stator through a self-excitation technique. Through such an arrangement, the rotor flux can be varied at different operating conditions by adjusting the excitation to these copper coils wound in the rotor.

In some embodiments, the permanent magnet assisted synchronous reluctance machines described herein may be controlled using a conventional permanent magnet machine control, such as maximum torque per ampere control scheme. In some embodiments, the permanent magnet assisted synchronous reluctance machines described herein may include any suitable slot and pole combination, such as 27 slots and 6 poles, 48 slots and 8 poles, 36 slots and 6 poles, or any suitable combination of slots and poles that yield relatively high slot and pole phase.

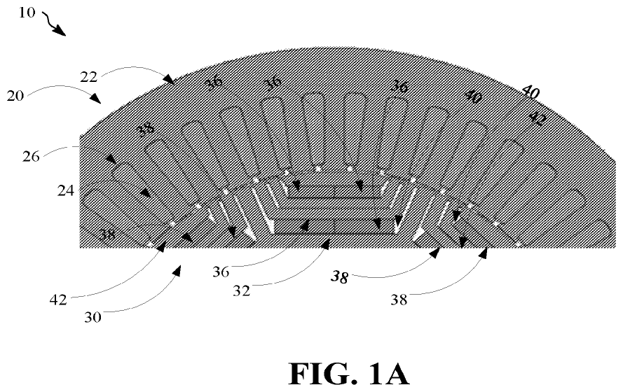

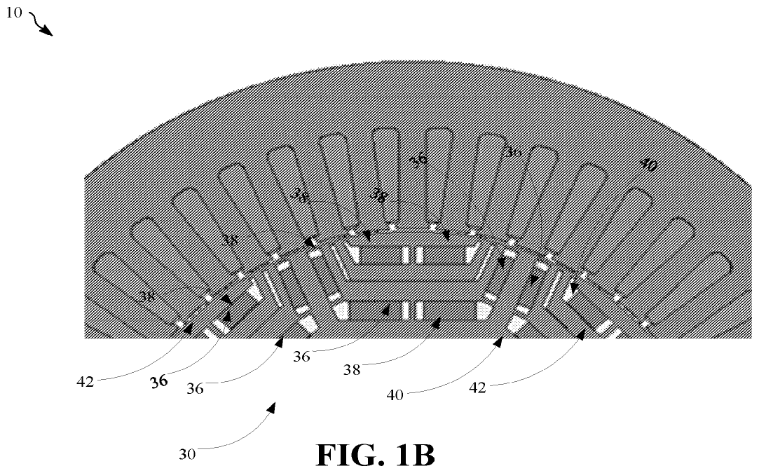

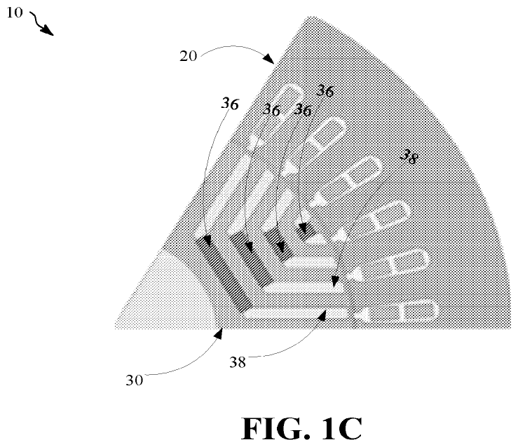

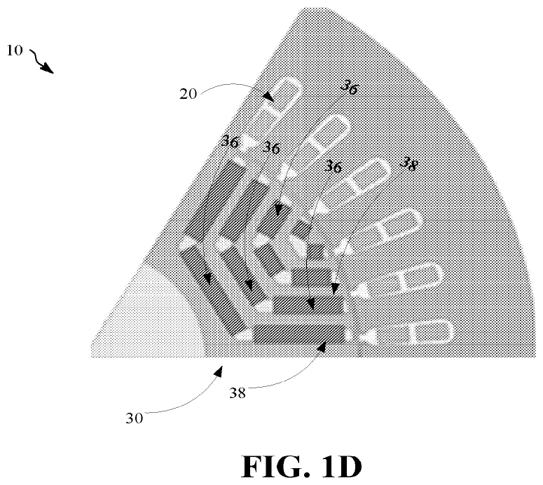

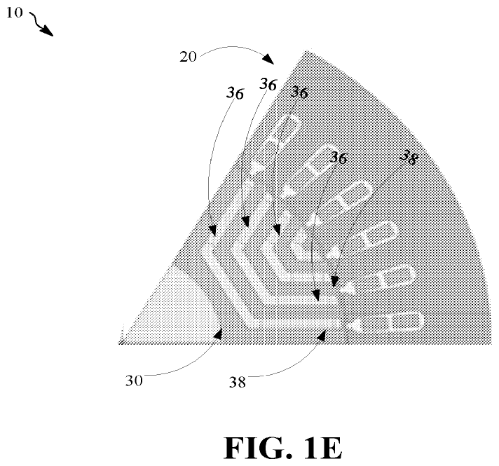

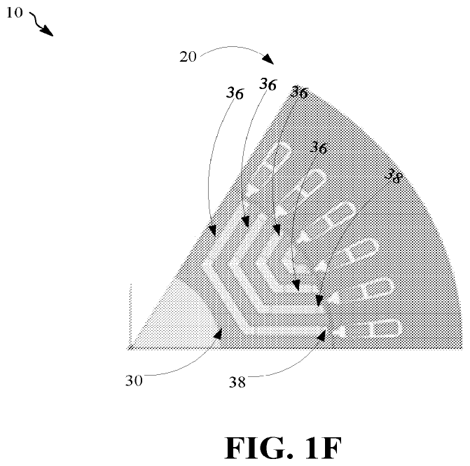

FIG. 1A generally illustrates partial top view of a permanent magnet assisted synchronous reluctance machine 10 according to the principles of the present disclosure. The machine 10 may include any suitable permanent magnet machine, such as an electric motor, generator, or other suitable permanent magnet machine. The machine 10 includes a stationary component, such as a stator 20 and a rotatable or moveable component, such as a rotor 30. As described, energy flows through the stator 20 to or from the rotor 30, causing the rotor 30 to rotate.

The stator 20 includes a back plate 22. The back plate 22 may comprise any suitable material, such as iron or other suitable material. The back plate 22 includes a substantially circular profile having an outer diameter and an inner diameter. The inner diameter may define a bore that is configured to receive the rotor 30.

The stator 20 includes a plurality of electrical conductors 24 comprising a magnetic core that includes one or more magnetic components. The electrical conductors 24 are disposed in corresponding recesses 26 radially disposed on the back plate 22. The magnetic core of the electrical conductors 24 may be wound in one or more windings of conductive wire, such as copper wire or other suitable conductive wire.

The electrical conductor 24 windings may include concentrated windings or distributed windings. In some embodiments, the electrical conductors 24 may be wound for multi-phases in a distributed winding or concentrated winding fashion. In some embodiments, the electrical conductors 24 may be wound for three-phases in a distributed winding or concentrated winding fashion. In some embodiments, the back plate 22 of the stator 20 may comprise electric steel or other suitable material.

In some embodiments, the rotor 30 includes a body 32 comprising a substantially circular profile having an outer diameter that corresponds to the inner diameter of the stator 20. Additionally, or alternatively, the rotor 30 includes an inner diameter defining a central bore. The body 32 may comprise an electric steel or other suitable material.

In some embodiments, the rotor 30 is configured to generate high torque density and to operate at a relatively high efficiency. For example, as will be described, the rotor 30 may include at least one ferrite magnet. The at least one ferrite magnet may have operating characteristics, such as a relatively low remnant flux density compared to typical NdFeB magnets operating at the similar temperatures, which may cause the rotor 30 to generate high torque density and operate at a relatively high efficiency.

In some embodiments, the rotor 30 is configured to be relatively highly salient, such that the rotor 30 may include a relatively high component of reluctance torque. Additionally, or alternatively, the rotor 30 may be configured to generate a magnet torque component when the rotor 30 includes at least one ferrite magnet and/or a combination of at least one ferrite magnet and at least one NdFeB magnets, as will be described.

In some embodiments, the rotor 30 is configured to accommodate mechanical forces acting at high speed and torque conditions in operation. In some embodiments, the rotor 30 may include a combination of features and characteristics of any of the rotor features and characteristics described herein.

The rotor 30 includes one or more magnets 36 disposed on a surface of the body 32. The magnets 36 may include permanent magnets or other suitable magnet. For example, the magnets 36 may include ferrite magnets, neodymium (NdFeB) magnets, other suitable magnets, or a combination thereof. The magnets 36 are disposed in corresponding recesses 38 of the body 32. The recesses 38 may comprise similar dimensions, or different dimensions. For example, some recesses 38 may include a first set of dimensions (e.g., a width and a length) and other recesses 38 include a second set of dimensions different from the first set of dimensions. In some embodiments, the recesses 38 include various sets of dimensions, such that any of the recesses 38 may include any suitable set of dimensions.

In some embodiments, the rotor 30 may include one or more air gaps 40 disposed proximate corresponding recesses 38. During operation, rotation of the rotor 30 may cause magnetic flux generated by magnets 36 to be directed toward the air gaps 40. Additionally, or alternatively, air flowing through the machine 10 resulting from rotation of the rotor 30 may be forced or directed toward the air gaps 40, which may provide natural cooling for the rotor 30 during operation.

In some embodiments, the rotor 30 may include one or more bridges 42 disposed between the corresponding recesses 38 (e.g., between recesses 38 having similar or dissimilar sets of dimensions, as described). The bridges 42 may comprise iron or other suitable material. In some embodiments, a number of layers of recesses 38 of the rotor 30 and a number of bridges 42 may be equal and may comprise more than two layers of recesses 38 and two bridges 42.

In some embodiments, the rotor 30 may include magnets 36 in some of the recesses 38 and not in other recesses 38. The magnets 36 disposed in some of the recesses 38 may include ferrite magnets, NdFeB magnets, or a combination thereof. In some embodiments, as is generally illustrated in FIG. 1B, the rotor 30 may include magnets 36 in each corresponding recess 38. The magnets 36 disposed in each corresponding recess 38 may include ferrite magnets, NdFeB magnets, or a combination thereof.

FIGS. 1C-1F generally illustrate magnet and recess arrangements for the rotor 30. It should be noted that FIGS. 1A and 1B illustrate an arrangement of magnets and recesses for the rotor 30, as described, in addition to the arrangements illustrated in FIGS. 1C-1F. Each arrangement illustrated in FIGS. 1C-1F includes a plurality of magnets 36 disposed in some of the recesses 38 and a plurality of recesses 38 without magnets 36 disposed therein. In each arrangements illustrated in FIGS. 1C-1F, the magnets 36 may include ferrite magnets, NdFeB magnets, or a combination thereof. In some embodiments, the rotor 30 includes at least one of the arrangements illustrated in FIGS. 1A-1F. In some embodiments, the rotor 30 includes a combination of magnet and recess arrangements illustrated in FIGS. 1A-1F.

In some embodiments, the machine 10 may be controlled using a conventional permanent magnet machine control, such as maximum torque per ampere control scheme. In some embodiments, the machine 10 may include any suitable slot and pole combination, such as 27 slots and 6 poles, 48 slots and 8 poles, 36 slots and 6 poles, or any suitable combination of slots and poles that yield relatively high slot and pole phase.

In some embodiments, a permanent magnet assisted synchronous reluctance machine includes a stator that includes a plurality of electrical conductors radially disposed on the stator and a rotor that includes a body having an outer diameter corresponding to an inner diameter of the stator and a plurality of recesses disposed on a surface of the rotor. The permanent magnet assisted synchronous reluctance machine also includes at least one ferrite magnet disposed in a corresponding recess of the plurality of recesses.

In some embodiments, the permanent magnet assisted synchronous reluctance machine also includes a plurality of ferrite magnets disposed in corresponding recesses of the plurality of recesses. In some embodiments, the permanent magnet assisted synchronous reluctance machine also includes at least one neodymium magnet disposed in a corresponding recess of the plurality of recesses. In some embodiments, the permanent magnet assisted synchronous reluctance machine also includes a plurality of ferrite magnets disposed in corresponding recesses of the rotor and a plurality of neodymium magnets disposed in other corresponding recesses of the rotor. In some embodiments, the rotor comprises an electric steel material and copper coils wound around slots of the rotor. In some embodiments, the stator comprises an electric steel material. In some embodiments, the permanent magnet assisted synchronous reluctance machine also includes an air gap disposed proximate the at least one ferrite magnet. In some embodiments, the rotor is configured to generate a high torque density and a constant output power from a base speed to a maximum speed. In some embodiments, the permanent magnet assisted synchronous reluctance machine also includes at least one iron bridge disposed between two corresponding recesses of the rotor. In some embodiments, some of the recesses of the rotor include a first set of dimensions and wherein others of the recesses of the rotor include a second set of dimensions different from the first set of dimensions.

In some embodiments, an electric machine includes a stator that includes a plurality of electrical conductors radially disposed on the stator. The electric machine also includes a rotor that includes a body having an outer diameter corresponding to an inner diameter of the stator and a plurality of recesses disposed on a surface of the rotor. The electric machine also includes at least one magnet disposed in a corresponding recess of the plurality of recesses and an air gap disposed proximate the at least one magnet, wherein the rotor is configured to cause magnetic flux generated by the at least one magnet to be directed toward the air gap.

In some embodiments, the electric machine also includes a plurality magnets disposed in corresponding recesses of the plurality of recesses. In some embodiments, the at least one magnet includes a neodymium magnet. In some embodiments, the electric machine also includes a plurality of magnets disposed in corresponding recesses of the rotor. In some embodiments, some of the plurality of magnets include ferrite magnets and others of the plurality of magnets include neodymium magnets. In some embodiments, the rotor comprises an electric steel material and copper coils wound around slots of the rotor. In some embodiments, the stator comprises an electric steel material. In some embodiments, the rotor is configured to generate a high torque density and a constant output power from a base speed to a maximum speed. In some embodiments, the electric machine also includes at least one iron bridge disposed between two corresponding recesses of the rotor. In some embodiments, some of the recesses of the rotor include a first set of dimensions and others of the recesses of the rotor include a second set of dimensions different from the first set of dimensions.

In some embodiments, a permanent magnet assisted synchronous reluctance machine includes a stator that includes a plurality of electrical conductors radially disposed on the stator and a rotor that includes a body having an outer diameter corresponding to an inner diameter of the stator and at least a first recess and a second recess disposed on a surface of the rotor. The permanent magnet assisted synchronous reluctance machine also includes an iron bridge disposed between the first recess and the second recess, a first magnet disposed in one of the first recess and the second recess, and a second magnet disposed in the other of the first recess and the second recess. The permanent magnet assisted synchronous reluctance machine also includes a first air gap disposed proximate the first recess and a second air gap disposed proximate the second recess, wherein rotation of the rotor causes magnetic flux generated by the first magnet and the second magnet to be directed toward the first air gap and the second air gap.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

1. A permanent magnet assisted synchronous reluctance machine comprising:
a stator that includes a plurality of electrical conductors radially disposed on the stator;
a rotor that includes a body having an outer diameter corresponding to an inner diameter of the stator and a plurality of recesses disposed on a surface of the rotor; and
at least one ferrite magnet disposed in a corresponding recess of the plurality of recesses.

2. The permanent magnet assisted synchronous reluctance machine of claim 1, further comprising a plurality of ferrite magnets disposed in corresponding recesses of the plurality of recesses.

3. The permanent magnet assisted synchronous reluctance machine of claim 1, further comprising at least one neodymium magnet disposed in a corresponding recess of the plurality of recesses.

4. The permanent magnet assisted synchronous reluctance machine of claim 1, further comprising a plurality of ferrite magnets disposed in corresponding recesses of the rotor and a plurality of neodymium magnets disposed in other corresponding recesses of the rotor.

5. The permanent magnet assisted synchronous reluctance machine of claim 1, wherein the rotor comprises an electric steel material and copper coils wound around slots of the rotor.

6. permanent magnet assisted synchronous reluctance machine of claim 5, wherein the stator comprises an electric steel material.

7. The permanent magnet assisted synchronous reluctance machine of claim 1, further comprising an air gap disposed proximate the at least one ferrite magnet.

8. The permanent magnet assisted synchronous reluctance machine of claim 1, wherein the rotor is configured to generate a high torque density and a constant output power from a base speed to a maximum speed.

9. The permanent magnet assisted synchronous reluctance machine of claim 1, further comprising at least one iron bridge disposed between two corresponding recesses of the rotor.

10. The permanent magnet assisted synchronous reluctance machine of claim 1, wherein some of the recesses of the rotor include a first set of dimensions and wherein others of the recesses of the rotor include a second set of dimensions different from the first set of dimensions.

11. An electric machine comprising:
a stator that includes a plurality of electrical conductors radially disposed on the stator;
a rotor that includes a body having an outer diameter corresponding to an inner diameter of the stator and a plurality of recesses disposed on a surface of the rotor;
at least one magnet disposed in a corresponding recess of the plurality of recesses; and
an air gap disposed proximate the at least one magnet, wherein the rotor is configured to cause magnetic flux generated by the at least one magnet to be directed toward the air gap.

12. The electric machine of claim 11, further comprising a plurality magnets disposed in corresponding recesses of the plurality of recesses.

13. The electric machine of claim 11, wherein the at least one magnet includes a neodymium magnet.

14. The electric machine of claim 11, further comprising a plurality of magnets disposed in corresponding recesses of the rotor, wherein some of the plurality of magnets include ferrite magnets and others of the plurality of magnets include neodymium magnets.

15. The electric machine of claim 11, wherein the rotor comprises an electric steel material and copper coils wound around slots of the rotor.

16. The electric machine of claim 15, wherein the stator comprises an electric steel material.

17. The electric machine of claim 11, wherein the rotor is configured to generate a high torque density and a constant output power from a base speed to a maximum speed.

18. The electric machine of claim 11, further comprising at least one iron bridge disposed between two corresponding recesses of the rotor.

19. The electric machine of claim 11, wherein some of the recesses of the rotor include a first set of dimensions and wherein others of the recesses of the rotor include a second set of dimensions different from the first set of dimensions.

20. A permanent magnet assisted synchronous reluctance machine comprising:
a stator that includes a plurality of electrical conductors radially disposed on the stator;
a rotor that includes a body having an outer diameter corresponding to an inner diameter of the stator and at least a first recess and a second recess disposed on a surface of the rotor;
an iron bridge disposed between the first recess and the second recess;
a first magnet disposed in one of the first recess and the second recess;
a second magnet disposed in the other of the first recess and the second recess;
a first air gap disposed proximate the first recess; and
a second air gap disposed proximate the second recess, wherein rotation of the rotor causes magnetic flux generated by the first magnet and the second magnet to be directed toward the first air gap and the second air gap.
